(19) United States
(12) Patent Application Publication
(10) Pub. No.: US 2016/0364742 A1
(43) Pub. Date: Dec. 15, 2016

(54) REWARDS SYSTEM AND METHOD

(71) Applicant: Ajani Harris-Williams, New Rochelle, NY (US)

(72) Inventor: Ajani Harris-Williams, New Rochelle, NY (US)

(21) Appl. No.: 15/179,231

(22) Filed: Jun. 10, 2016

Related U.S. Application Data
(60) Provisional application No. 62/174,831, filed on Jun. 12, 2015.

(51) Int. Cl. G06Q 30/02; G06Q 50/00

(52) U.S. Cl. CPC G06Q 30/0226; G06Q 50/01

(57) ABSTRACT

A computer-implemented method, computer program product and computing system for establishing a multi-tier rewards account for a user within a social network. The multi-tier rewards account includes a system-level rewards account and a first entity-level rewards account associated with a first entity within the social network. First entity-level points are added to the first entity-level rewards account based upon entity-level activities performed by the user concerning the first entity within the social network. System-level points are added to the system-level rewards account based, at least in part, upon the first entity-level points added to the first entity-level rewards account.

### RELATED APPLICATION

This application claims the benefit of U.S. Provisional Application No. 62/174,831, filed on 12 Jun. 2015, entitled “Reward System and Method”, the contents of which are incorporated herein by reference.

### TECHNICAL FIELD

This disclosure relates to reward systems and, more particularly, to reward systems within social networks,

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public web site in which they may post entries that are published for multiple people to read. Examples of such websites may include but are not limited to product/service review sites and topical blogs.

As is known in the art, the phrase social network may be used to refer to a group of technologies (e.g. Web-based and mobile technologies) that allow for users to engage in a quasi-real-time, interactive dialogue. Social networking websites have allowed people to interact and socialize in ways that were unimaginable ten years ago. For example, the use of such social networking websites has allowed for long lost friends to be reunited, long-distance friendships to be easily maintained, and information to be broadcast to groups of people. Further and through the use of such social networks, friends may schedule various types of events, such as online video chats and in-person gatherings.

### SUMMARY OF DISCLOSURE

In one implementation, a computer-implemented method is executed on a computing device and includes establishing a multi-tier rewards account for a user within a social network. The multi-tier rewards account includes a system-level rewards account and a first entity-level rewards account associated with a first entity within the social network. First entity-level points are added to the first entity-level rewards account based upon entity-level activities performed by the user concerning the first entity within the social network. System-level points are added to the system-level rewards account based, at least in part, upon the first entity-level points added to the first entity-level rewards account.

One or more of the following features may be included. First entity-level awards may be provided to the user based, at least in part, upon a total quantity of entity-level points included within the first entity-level rewards account. System-level awards may be provided to the user based, at least in part, upon a total quantity of system-level points included within the system-level rewards account. The multi-tier rewards account may further include a second entity-level rewards account associated with a second entity within the social network. Second entity-level points may be added to the second entity-level rewards account based upon entity-level activities performed by the user concerning the second entity within the social network. System-level points may be added to the system-level rewards account based, at least in part, upon the second entity-level points added to the second entity-level rewards account. Second entity-level awards may be provided to the user based, at least in part, upon a total quantity of entity-level points included within the second entity-level rewards account. The first entity may be a first sports entity and the second entity may be a second sports entity.

In another implementation, a computer program product resides on a computer readable medium and has a plurality of instructions stored on it. When executed by a processor, the instructions cause the processor to perform operations including establishing a multi-tier rewards account for a user within a social network. The multi-tier rewards account includes a system-level rewards account and a first entity-level rewards account associated with a first entity within the social network. First entity-level points are added to the first entity-level rewards account based upon entity-level activities performed by the user concerning the first entity within the social network. System-level points are added to the system-level rewards account based, at least in part, upon the first entity-level points added to the first entity-level rewards account.

One or more of the following features may be included. First entity-level awards may be provided to the user based, at least in part, upon a total quantity of entity-level points included within the first entity-level rewards account. System-level awards may be provided to the user based, at least in part, upon a total quantity of system-level points included within the system-level rewards account. The multi-tier rewards account may further include a second entity-level rewards account associated with a second entity within the social network. Second entity-level points may be added to the second entity-level rewards account based upon entity-level activities performed by the user concerning the second entity within the social network. System-level points may be added to the system-level rewards account based, at least in part, upon the second entity-level points added to the second entity-level rewards account. Second entity-level awards may be provided to the user based, at least in part, upon a total quantity of entity-level points included within the second entity-level rewards account. The first entity may be a first sports entity and the second entity may be a second sports entity.

In another implementation, a computing system includes a processor and a memory system configured to perform operations including establishing a multi-tier rewards account for a user within a social network. The multi-tier rewards account includes a system-level rewards account and a first entity-level rewards account associated with a first entity within the social network. First entity-level points are added to the first entity-level rewards account based upon entity-level activities performed by the user concerning the first entity within the social network. System-level points are added to the system-level rewards account based, at least in part, upon the first entity-level points added to the first entity-level rewards account.

One or more of the following features may be included. First entity-level awards may be provided to the user based, at least in part, upon a total quantity of entity-level points included within the first entity-level rewards account. System-level awards may be provided to the user based, at least in part, upon a total quantity of system-level points included within the system-level rewards account. The multi-tier rewards account may further include a second entity-level rewards account associated with a second entity within the social network. Second entity-level points may be added to the second entity-level rewards account based upon entity-level activities performed by the user concerning the second entity within the social network. System-level points may be added to the system-level rewards account based, at least in part, upon the second entity-level points added to the second entity-level rewards account. Second entity-level awards may be provided to the user based, at least in part, upon a total quantity of entity-level points included within the second entity-level rewards account. The first entity may be a first sports entity and the second entity may be a second sports entity.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a reward process according to an embodiment of the present disclosure;

FIG. 2 is a diagrammatic view of a display screen rendered according to an embodiment of the present disclosure;

FIG. 3 is a diagrammatic view of a display screen rendered according to an embodiment of the present disclosure;

FIG. 4 is a flowchart of the reward process of FIG. 1 according to an embodiment of the present disclosure; and

FIG. 5 is a diagrammatic view of a multi-tier rewards account generated by the reward process of FIG. 1 according to an embodiment of the present disclosure.

Like reference symbols in the various drawings indicate like elements.

### DETAILED DESCRIPTION OF THE PREFERRED EMBODIMENTS

System Overview

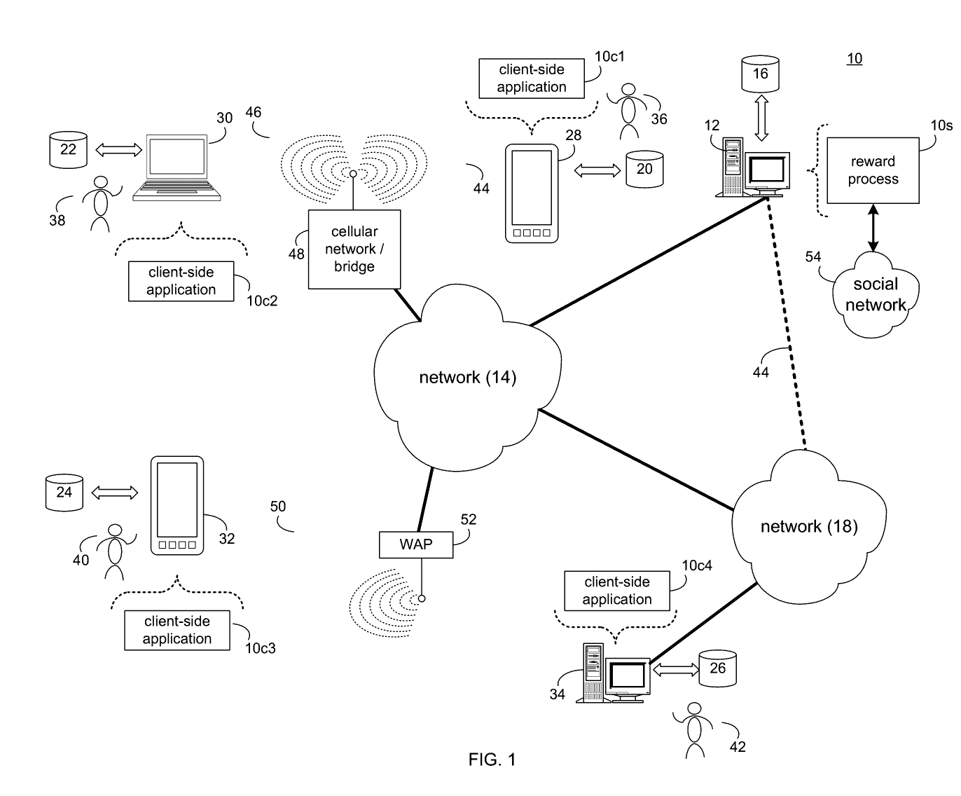

In FIG. 1, there is shown reward process 10. Reward process 10 may be implemented as a server-side process, a client-side process, or a hybrid server-side/client-side process. For example, reward process 10 may be implemented as a purely server-side process via reward process 10s. Alternatively, reward process 10 may be implemented as a purely client-side process via one or more of client-side application 10c 1, client-side application 10c2, client-side application 10c3, and client-side application 10c4. Alternatively still, reward process 10 may be implemented as a hybrid server-side/client-side process via reward process 10s in combination with one or more of client-side application 10c1, client-side application 10 c 2, client-side application 10 c3, and client-side application 10c4. Accordingly, reward process 10 as used in this disclosure may include any combination of reward process 10s, client-side application 10c1, client-side application 10c2, client-side application 10c3, and client-side application 10c4.

Reward process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing network.

The instruction sets and subroutines of reward process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side applications 10c 1, 10c2, 10c3, 10c4 may include but are not limited to a web browser, a game console user interface, or a specialized application (e.g., an application running on e.g., the Android™ platform or the iOS™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, smartphone 28, laptop computer 30, personal digital assistant 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access reward process 10 directly through network 14 or through secondary network 18. Further, reward process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, smartphone 28 and laptop computer 30 are shown wirelessly coupled to network 14 via wireless communication channels 44, 46 (respectively) established between smartphone 28, laptop computer 30 (respectively) and cellular network/bridge 48 which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As is known in the art, a social network (e.g., Facebook™) is a network that allows entities to interact socially. Examples of these entities may include human entities and non-human entities. For example, individual people may be members of a social network. Additionally, individuals may form a group and the group may be a member of a social network. Examples of non-human entities may include but are not limited to corporate entities (e.g., companies and organizations), athletic entities (e.g., sports teams and leagues), political entities (e.g., political parties and movements), location entities (e.g., buildings and structures), and event entities (e.g., concerts and sporting events). Through the use of social networks, entities may publish content, which may be reviewed and responded to by other entities of the social network.

Reward process 10 may be included within, executed within, or a portion of a social network (e.g., social network 54). As discussed above, the phrase social network may be used to refer to a group of technologies (e.g. web-based and mobile technologies) that allow for users to engage in a quasi-real-time, interactive dialogue. For illustrative purposes and for the following discussion, assume that social network 54 is a sports-themed social network, wherein users of social network 54 may review and comment on sports-related content.

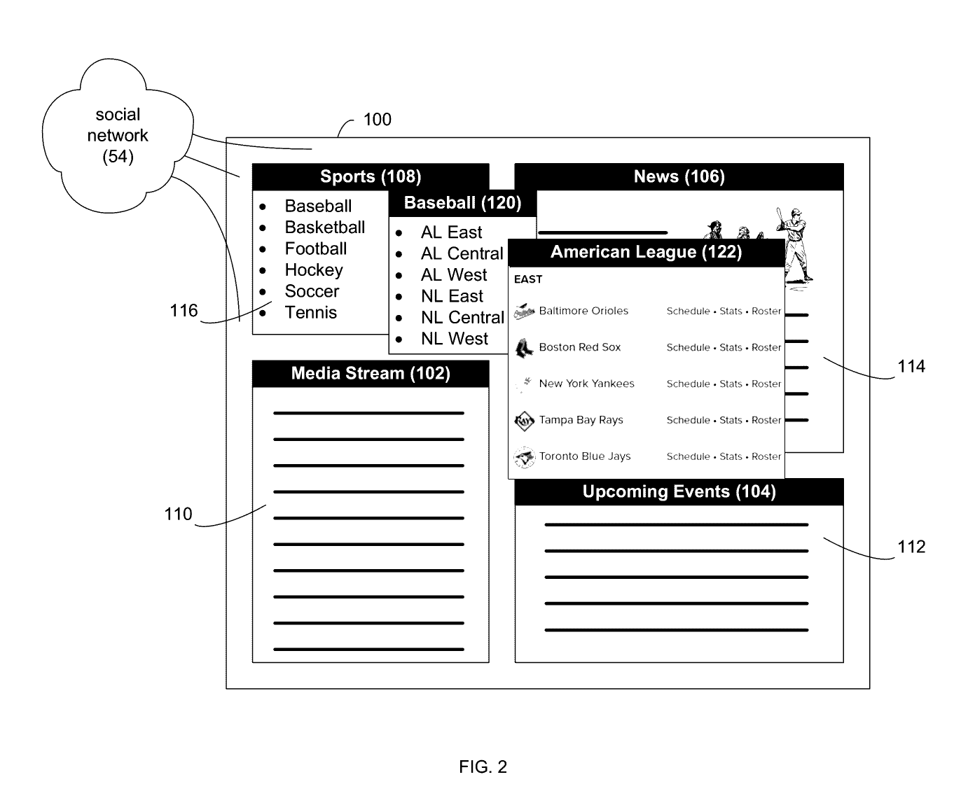

Referring also to FIG. 2, social network 54 may render graphical user interface 100, which may be divided into a plurality of sections, such as media stream section 102, upcoming events section 104, news section 106 and sports section 108. While graphical user interface 100 is described as including four sections, this is for illustrative purposes only and is not intended to be a limitation of this disclosure, as other configures are possible. For example, the number of sections may be increased or decreased in accordance with need and/or design criteria.

A user (e.g., user 36) of social network 54 may navigate sections 102, 104, 106, 108 to review the various content associated with these sections. For example, media stream section 102 may include streaming list 110 of content generated by users of social network 54. Accordingly, user 36 may select and review any of this content and “like” the content or provide commentary concerning the same. Further, upcoming event section 104 may include list 112 of upcoming sports-related events, such as games, celebrations, gatherings, etc. Through this section, user 36 may select and review any of these events and “like” the same, provide commentary on the event, and purchase tickets to the event. Additionally, news section 106 may include list 114 of sports-related news stories. Through this section, user 36 may select and review any of these news stories and “like” a story and provide commentary on a story. Further, sports section 108 may include list 116 of sports teams/leagues. Through this section, user 36 may select and review content related to a specific sports league or team, “like” the same and provide commentary on the same.

For example, assume that user 36 is a New York Yankees fan and wishes to review content concerning the New York Yankees. Accordingly, user 46 may select (in this example) “baseball” within sports section 108, which may result in social network 54 rendering “baseball” submenu 120. User 36 may then select “AL East” from “baseball” submenu 120, which may result in social network 54 rendering “American League” submenu 122. User 36 may then select “New York Yankees” from “American League” submenu 122.

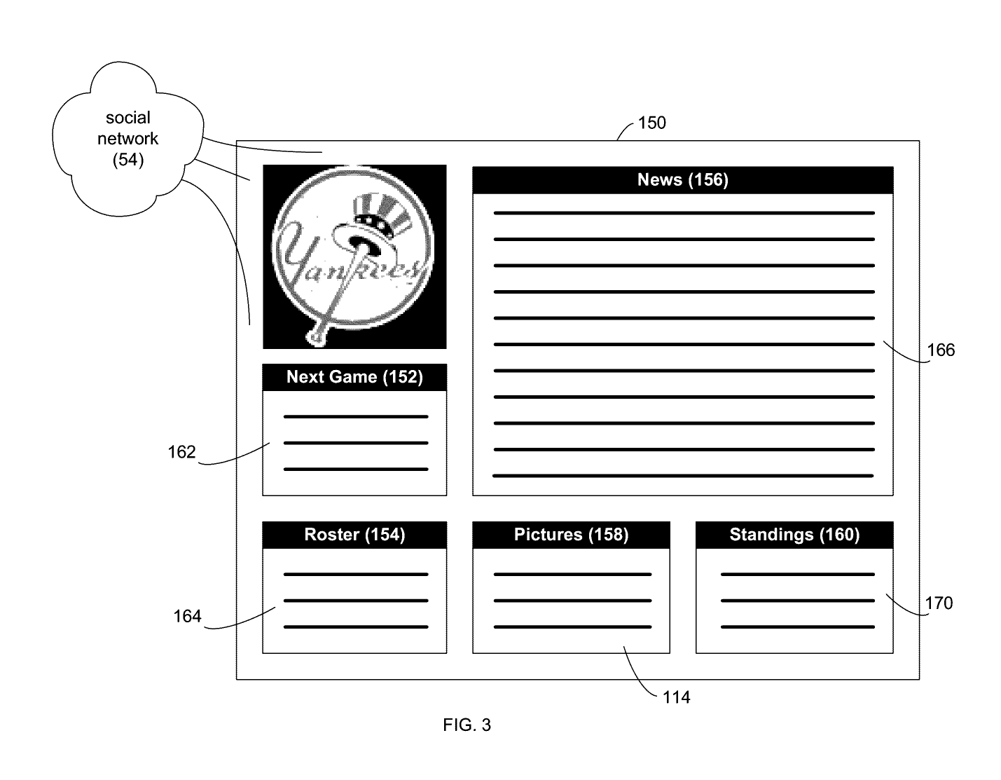

Referring also to FIG. 3, social network 54 may render “New York Yankees” page 150, which may be divided into a plurality of sections, such as next game section 152, roster section 154, news section 156, pictures section 158 and standings section 160. While “New York Yankees” page 150 is described as including five sections, this is for illustrative purposes only and is not intended to be a limitation of this disclosure, as other configures are possible. For example, the number of sections may be increased or decreased in accordance with need and/or design criteria.

User 36 of social network 54 may navigate sections 152, 154, 156, 158, 160 to review the various content associated with these sections. For example, next game section 152 may include information 162 (e.g., time, location, line up) concerning the next game the New York Yankees are playing. Accordingly, user 36 may select and review the information about the game, “like” the information about the game, provide commentary concerning the same, purchase tickets for the game, and check in at the game. Further, roster section 154 may include roster list 164 for the upcoming game. Through this section, user 36 may review roster list 164 and “like” the same and provide commentary on roster list 164. Additionally, news section 156 may include list 166 of New York Yankees related news stories. Through this section, user 36 may select and review any of these news stories and “like” the story and provide commentary on the story. Further, pictures section 158 may include list 168 of pictures of the New York Yankees. Through this section, user 36 may select and review these pictures, “like” the same and provide commentary on the same. Additionally, standings section 160 may include standings 170 for the New York Yankees. Through this section, user 36 may review these standings, “like” the same and provide commentary on the same.

Reward Process

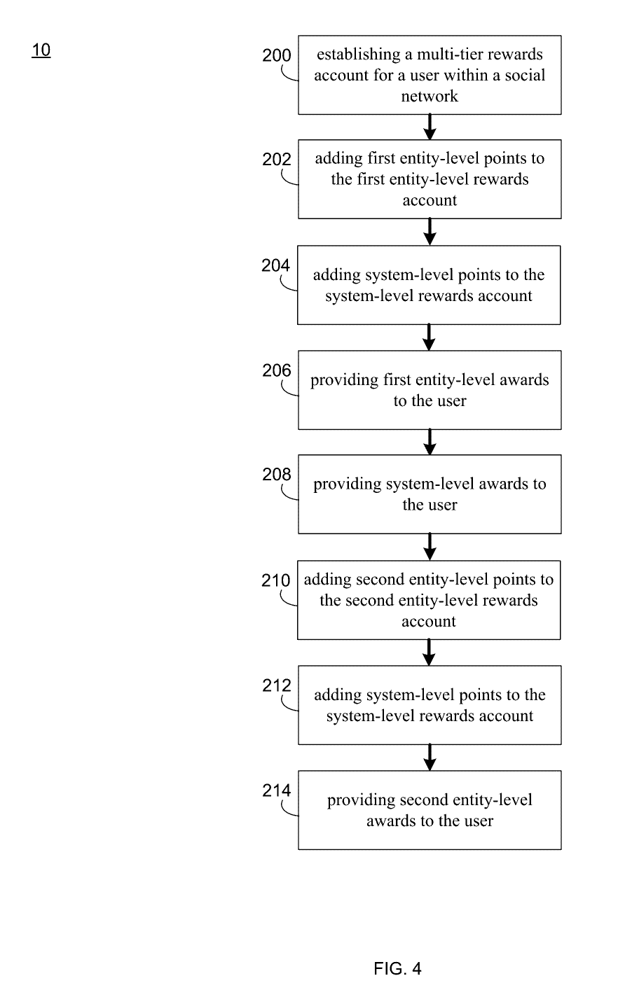

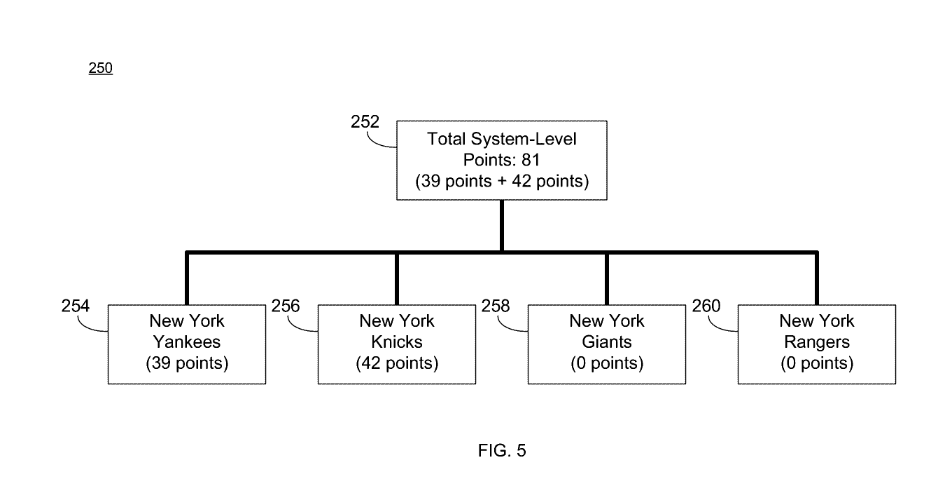

Referring also to FIGS. 4-5, reward process 10 may be configured to allow users (e.g., user 36) of social network 54 to acquire points when they process/consume content (to be discussed below in greater detail) within social networks 54. Reward process 10 may establish 200 multi-tier rewards account 250 for a user (e.g., user 36) within social network 54. Multi-tier rewards account 250 may include system-level rewards account 252 and one or more entity-level rewards accounts 254, 256, 258, 260. While in this particular example, multi-tier rewards account 250 is shown to include four entity-level rewards account (e.g., entity-level rewards accounts 254, 256, 258, 260), this is for illustrative purposes only and is not intended to be a limitation of this disclosure, as other configurations are possible.

Specifically, multi-tier rewards account 250 may include an entity-level rewards account for (in this example) as many entities (e.g., sports teams) as user 36 is interested in. For example, assume that user 36 is a New York sports fan. Accordingly, multi-tier rewards account 250 may include an entity-level rewards account for each of the favorite New York sports teams of user 36. Accordingly, multi-tier rewards account 250 for user 36 may include: first entity-level rewards account 254 associated with the New York Yankees; second entity-level rewards account 256 associated with the New York Giants; third entity-level rewards account 258 associated with the New York Knicks; and fourth entity-level rewards account 260 associated with the New York Rangers.

Assume that user 36 navigates to “New York Yankees” page 150 and performs activities concerning the content available via “New York Yankees” page 150 and acquires points concerning the same. Examples of such activities and the related point values are as follows

| Activity | Points |
|---|---|
| Reading a User Post | 1 |
| Commenting on a User Post | 2 |
| “Liking” a User Post | 1 |
| “Sharing” a User Post | 2 |
| Creating a New Post | 3 |
| Reviewing Written Content | 2 |
| Reviewing Photographic Content | 2 |
| Reviewing Video Content | 2 |
| Commenting on Content | 2 |
| “Liking” Content | 1 |
| “Sharing” Content | 1 |
| Checking into a Neighborhood Facility/Event | 5 |
| Checking into a High School Facility/Event | 10 |
| Checking into a Collegiate Facility/Event | 15 |
| Checking into a Professional Facility/Event | 20 |

While the above table defines a plurality of activities and assigns a point value to each of these activities, this is for illustrative purposes only and is not intended to be a limitation of this disclosure. For example, the number of events may be increased or decreased and the point value assigned to each activity may be adjusted based upon intent or design criteria. Accordingly, user 36 of social network 54 may navigate e.g., sections 152, 154, 156, 158, 160 to review the various content/posts associated with these sections, generate content/posts, and like & share content/posts.

Continuing with the above-stated example, in which user 36 perform activities concerning the content available via “New York Yankees” page 150, reward process 10 may add 202 first entity-level points to first entity-level rewards account 254 (i.e., the account associated with the New York Yankees) based upon entity-level activities performed by user 36 concerning the first entity (i.e., the New York Yankees) within social network 54.

Assume for this example, that user 36 reads ten users posts (for a total of ten points); reviews two pieces of written content (for a total of four points); “likes” five pieces of content (for a total of five points); and checks into Yankee Stadium to see a New York Yankees game (for a total of twenty points). Accordingly, reward process 10 may add 202 thirty-nine entity-level points to first entity-level rewards account 254 (i.e., the entity-level account associated with the New York Yankees).

Reward process 10 may add 204 system-level points to system-level rewards account 252 based, at least in part, upon the first entity-level points (i.e., the thirty-nine entity-level points) added to first entity-level rewards account 254. When adding 204 system-level points to system-level rewards account 252, these system-level points may be added 204 on a one-to-one basis or in accordance with any desired ratio. For this example, assume that the system-level points are added on a one-to-one basis. Accordingly, reward process 10 may add 204 thirty-nine system-level points to system-level rewards account 252.

Reward process 10 may provide 206 first entity-level awards to user 36 based, at least in part, upon a total quantity of entity-level points (i.e., thirty-nine entity-level points) included within first entity-level rewards account 254. Examples of such first entity-level awards may include but are not limited to status awards (e.g., “Certified Yankees Fan” status), monetary discounts (e.g., discounts on tickets/merchandise), and access to special events (e.g., access to fan related events/parties).

Additionally, reward process 10 may provide 208 system-level awards to user 36 based, at least in part, upon a total quantity of system-level points (i.e., thirty-nine system-level points) included within system-level rewards account 252. Examples of such system-level awards may include but are not limited to status awards (e.g., “Rookie Fan” status, “Varsity Fan” status, “Pro Fan” status, “All-Star Fan” status), monetary discounts (e.g., discounts on merchandise), and access to special events (e.g., access to sports related events/parties).

Continuing with the above-stated example, assume that user 36 performs activities concerning the content available via a “New York Knicks” page (not shown). Assume for this example, that user 36 reads five users posts (for a total of five points); reviews eight pieces of written content (for a total of sixteen points); “likes” one piece of content (for a total of one points); and checks into Madison Square Garden to see a New York Knicks game (for a total of twenty points). Reward process 10 may add 210 entity-level points (i.e., forty-two entity-level points) to second entity-level rewards account 256 (i.e., the entity-level account associated with the New York Knicks) based upon entity-level activities performed by user 36 concerning the second entity (i.e., the New York Knicks) within social network 54.

Again, reward process 10 may add 212 system-level points to system-level rewards account 252 based, at least in part, upon the second entity-level points (i.e., forty-two entity-level points) added to second entity-level rewards account 256. Accordingly, reward process 10 may add 212 forty-two system-level points to system-level rewards account 252, increasing the total quantity of system-level points from thirty-nine to eighty-one.

As above, reward process 10 may provide 214 second entity-level awards to user 36 based, at least in part, upon a total quantity of entity-level points (i.e., forty-two entity-level points) included within second entity-level rewards account 256. Examples of such second entity-level awards may include but are not limited to status awards (e.g., “Certified Knicks Fan” status), monetary discounts (e.g., discounts on tickets/merchandise), and access to special events (e.g., access to fan related events/parties).

The above-stated processes may be repeated for each piece of content that (in this example) user 36 processes/consumes within social network 54.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
establishing a multi-tier rewards account for a user within a social network, wherein the multi-tier rewards account includes a system-level rewards account and a first entity-level rewards account associated with a first entity within the social network;
adding first entity-level points to the first entity-level rewards account based upon entity-level activities performed by the user concerning the first entity within the social network; and
adding system-level points to the system-level rewards account based, at least in part, upon the first entity-level points added to the first entity-level rewards account.

2. The computer-implemented method of claim 1 further comprising:
providing first entity-level awards to the user based, at least in part, upon a total quantity of first entity-level points included within the first entity-level rewards account.

3. The computer-implemented method of claim 1 further comprising:
providing system-level awards to the user based, at least in part, upon a total quantity of system-level points included within the system-level rewards account.

4. The computer-implemented method of claim 1 wherein the multi-tier rewards account further includes a second entity-level rewards account associated with a second entity within the social network.

5. The computer-implemented method of claim 4 further comprising:
adding second entity-level points to the second entity-level rewards account based upon entity-level activities performed by the user concerning the second entity within the social network; and
adding system-level points to the system-level rewards account based, at least in part, upon the second entity-level points added to the second entity-level rewards account.

6. The computer-implemented method of claim 5 further comprising:
providing second entity-level awards to the user based, at least in part, upon a total quantity of entity-level points included within the second entity-level rewards account.

7. The computer-implemented method of claim 5 wherein:
the first entity is a first sports entity; and
the second entity is a second sports entity.

8. A computer program product residing on a computer readable medium having a plurality of instructions stored thereon which, when executed by a processor, cause the processor to perform operations comprising:
establishing a multi-tier rewards account for a user within a social network, wherein the multi-tier rewards account includes a system-level rewards account and a first entity-level rewards account associated with a first entity within the social network;
adding first entity-level points to the first entity-level rewards account based upon entity-level activities performed by the user concerning the first entity within the social network; and
adding system-level points to the system-level rewards account based, at least in part, upon the first entity-level points added to the first entity-level rewards account.

9. The computer program product of claim 8 further comprising instructions for:
providing first entity-level awards to the user based, at least in part, upon a total quantity of first entity-level points included within the first entity-level rewards account.

10. The computer program product of claim 8 further comprising instructions for:
providing system-level awards to the user based, at least in part, upon a total quantity of system-level points included within the system-level rewards account.

11. The computer program product of claim 8 wherein the multi-tier rewards account further includes a second entity-level rewards account associated with a second entity within the social network.

12. The computer program product of claim 11 further comprising instructions for:
adding second entity-level points to the second entity-level rewards account based upon entity-level activities performed by the user concerning the second entity within the social network; and
adding system-level points to the system-level rewards account based, at least in part, upon the second entity-level points added to the second entity-level rewards account.

13. The computer program product of claim 12 further comprising instructions for:
providing second entity-level awards to the user based, at least in part, upon a total quantity of entity-level points included within the second entity-level rewards account.

14. The computer program product of claim 12 wherein:
the first entity is a first sports entity; and
the second entity is a second sports entity.

15. A computing system including a processor and memory configured to perform operations comprising:
establishing a multi-tier rewards account for a user within a social network, wherein the multi-tier rewards account includes a system-level rewards account and a first entity-level rewards account associated with a first entity within the social network;
adding first entity-level points to the first entity-level rewards account based upon entity-level activities performed by the user concerning the first entity within the social network; and
adding system-level points to the system-level rewards account based, at least in part, upon the first entity-level points added to the first entity-level rewards account.

16. The computing system of claim 15 further configured to perform operations comprising:
providing first entity-level awards to the user based, at least in part, upon a total quantity of first entity-level points included within the first entity-level rewards account.

17. The computing system of claim 15 further configured to perform operations comprising:
providing system-level awards to the user based, at least in part, upon a total quantity of system-level points included within the system-level rewards account.

18. The computing system of claim 15 wherein the multi-tier rewards account further includes a second entity-level rewards account associated with a second entity within the social network.

19. The computing system of claim 18 further configured to perform operations comprising:
adding second entity-level points to the second entity-level rewards account based upon entity-level activities performed by the user concerning the second entity within the social network; and
adding system-level points to the system-level rewards account based, at least in part, upon the second entity-level points added to the second entity-level rewards account.

20. The computing system of claim 19 further configured to perform operations comprising:
providing second entity-level awards to the user based, at least in part, upon a total quantity of entity-level points included within the second entity-level rewards account.

21. The computing system of claim 19 wherein:
the first entity is a first sports entity; and
the second entity is a second sports entity.
